(19) United States
(12) Patent Application Publication
(10) Pub. No.: US 2020/0332824 A1
(43) Pub. Date: Oct. 22, 2020

(54) SEMIFINISHED PRODUCT FOR PRODUCING A FIBER-REINFORCED COMPOSITE ELEMENT HAVING A FASTENING HOLE OR A FASTENING PROTRUSION, COMPOSITE ELEMENT AND METHOD FOR PRODUCING A COMPOSITE ELEMENT

(71) Applicant: A. RAYMOND ET CIE, Grenoble (FR)

(72) Inventors: Urs GRETHER, Efringen-Kirchen (DE); Till RUFFING, Laufenburg (Baden) (DE); Thomas GRATHWOL, Schliengen (DE); Yannick ROHLOFF, Rheinfelden (DE); Jens RICHWALSKY, Steinen (DE)

(21) Appl. No.: 16/757,043

(22) PCT Filed: Oct. 11, 2018
(86) PCT No.: PCT/EP2018/077733

§ 371 Date: Apr. 17, 2020

(30) Foreign Application Priority Data
Oct. 27, 2017 (DE) 10 2017 010 010.1

(51) Int. Cl. F16B 37/04; B29C 70/86; B29D 1/00

(52) U.S. Cl. CPC F16B 37/048; B29D 1/005; B29C 70/86

(57) ABSTRACT

The invention relates to a composite element having fibers embedded in a hardened resin and an insert piece likewise embedded in the resin, which insert piece has a head and a tip. A pin is provided between the head and the tip, the pin extending along a longitudinal axis extending from the head to the tip, wherein a fastening hole is defined by the head, and/or a fastening protrusion extends from the head. A recess defined by the pin, at which recess is presented a holding surface facing the head and forming an angle with the longitudinal axis of >0° and <180°.

### CROSS-REFERENCE TO RELATED APPLICATIONS

This application is the National Stage of International Application No. PCT/EP2018/077733, filed on 11 Oct. 2018, which claims priority to and all advantages of German Patent Application No. 102017010010.1, filed on 27 Oct. 2017, the content of which is hereby incorporated by reference.

### FIELD OF THE INVENTION

The disclosure relates to a semi-finished product for producing a fiber-reinforced composite element defining a fastening hole or having a fastening protrusion, and to a composite element having fibers embedded in a hardened resin and to an insert piece likewise embedded in the resin, and to a method for producing such a composite element.

### BACKGROUND OF THE INVENTION

It is known from the prior art how to use composite elements which have fibers embedded in a resin to produce at least parts of devices—in particular, vehicles, e.g., boats, aircraft, or helicopters, but above all land vehicles such as motor vehicles or bicycles—both with respect to attachments, but increasingly also for the basic structure—for example, for a frame structure. If, in the case of such composite elements, a further component is to be fastened to the composite element, it is in principle possible to introduce a screw or rivet into the composite element with its hardened resin and the fibers embedded in the hardened resin. However, the introduction of a screw or a bolt into a composite element with hardened resin leads to mechanical damage to the composite element. This mechanical damage can lead to impairment when the composite element is used. Alternatively, it is conceivable to adhesively bond the component to be connected to the composite element to the composite element. Compared to the use of screws, however, adhesive bonding has the disadvantage that the component cannot be removed from the composite element without being destroyed. For example, if a fender of a vehicle (an example of a component) is adhesively bonded to a frame structure of a motor vehicle (an example of a composite element according to the invention), then, in case of a minor accident in which only the fender needs replacing, the fender can only be detached from the frame and replaced by a new fender with extensive effort.

### SUMMARY OF THE INVENTION

Given this background, the disclosure is to propose a composite element having fibers embedded in a hardened resin and a method for the production thereof which allow easy joining of components to the composite element, but at the same time do not cause mechanical damage to the composite element, as may be the case with subsequent introduction of a screw into a composite element having hardened resin.

The disclosure is based upon the basic idea of embedding an insert piece during the production of the composite element, which insert piece is then embedded in the resin along with the fibers during hardening of the resin. Thus, the disclosure avoids the need to drive fastening elements such as screws or bolts into the composite element after hardening of the resin. At the same time, the use of an insert piece embedded in the hardened resin offers the possibility of using this insert piece to form a fastening hole or a fastening protrusion in or on the composite element which can later be used for producing a detachable connection to a component to be fastened to the composite element.

The disclosure can already be implemented by the provision of a semi-finished product suited for producing a fiber-reinforced composite element having a fastening hole or a fastening protrusion. Such a semi-finished product is the smallest unit capable of being sold in which the disclosure can be implemented. When considering the current manufacturing stages of fiber-reinforced composite elements, it is common practice at present for suppliers to supply a manufacturer of fiber-reinforced composite elements with the basic components individually produced by the suppliers, from which the fiber-reinforced composite element is then produced. Therefore, such a manufacturer will often procure the fibers to be used or the fiber-woven fabrics to be used from a supplier, just as the manufacturer procures, for example, the resin, any filler being used, or any hardener being used from a supplier. It is also conceivable for such a manufacturer to obtain the insert piece to be embedded into the resin from a supplier in the form of a specially-formed, semi-finished product.

The semi-finished product according to the disclosure is suited for producing a fiber-reinforced composite element having a fastening hole or a fastening protrusion. For this purpose, it has a fastening hole or a fastening protrusion, so that the introduction of this semi-finished product during production of the composite element creates a fastening hole or a fastening protrusion in or on the composite element.

The semi-finished product according to the disclosure has a head and a tip. A pin is provided between the head and the tip and extends along a longitudinal axis pointing from the head to the tip. This basic shape of the semi-finished product enables a particularly simple introduction of the semi-finished product between the fibers of the composite element. Particularly for the embodiments in which a fiber-woven fabric (in contrast to loose fibers) is used for the composite element, this basic structure is particularly good at enabling the semi-finished product to be pushed between the fibers of the fiber-woven fabric during the production process of the composite element. In addition, the basic structure selected can reduce the risk of breaking or fracturing of the surrounding fibers during insertion.

In a specific embodiment, the head has a greater extension (measured as the distance from the longitudinal axis in the radial direction) in at least one direction perpendicular to the longitudinal axis—typically in the majority of directions perpendicular to the longitudinal axis, and particularly in all directions perpendicular to the longitudinal axis—than the maximum extension of the pin and/or than the maximum extension of the tip in this direction. This affords the possibility of using the head as an insertion limiter, i.e.,

of using the dimensions of the head to determine how deeply the semi-finished product plunges into the fibers during introduction. Such a design of the head also offers the possibility of using the head as a manipulator for the semi-finished product—in particular, as a contact surface for retaining elements, e.g., retaining elements in a molded form for a fiber-reinforced composite element, using which the position of the semi-finished product in space can be fixed.

The semi-finished product according to the disclosure has a fastening hole defined by the head, and/or a fastening protrusion extending from the head.

On the pin of the semi-finished product according to the disclosure, a recess is provided on which is formed a holding surface facing the head and forming an angle to the longitudinal axis of >0° and <180° alternatively an angle of >10° and <170°, alternatively an angle of >20° and <160°, alternatively an angle of >30° and <150°, alternatively an angle of >40° and <140°, alternatively an angle of >50° and <130°, alternatively an angle of >60° and <120°, alternatively an angle of >70° and <110°, alternatively an angle of >80° and <100°, alternatively an angle of 90°. The recess according to the disclosure provided on the pin affords the possibility that the fibers of the composite element and/or the resin of the composite element and/or the filler (if provided) and/or the hardener (if provided) of the composite element can interlock with the pin during the production of the composite element. This means that when viewed along the longitudinal axis or parallel to the longitudinal axis, elements of the pin alternate with fibers or with resin, filler, or hardener. This interlocking offers the advantage that pull-out of the semi-finished product from the composite element is made more difficult. The interlocking proposed by the disclosure (achieved by provision of the recess with its holding surface) counteracts pull-out of the semi-finished product via greater holding forces than would be the case for a pin with a smooth outer surface.

A holding surface facing the head is understood to mean a surface whose surface normal (insofar as the holding surface is planar) has a component which points in the direction of the head. If the holding surface is not planar, e.g., if the holding surface is crowned, a holding surface facing the head is understood to mean one which has at least one surface normal which has a component which points in the direction of the head. A complement to a holding surface facing the head would be a surface facing the tip.

In a specific embodiment, the semi-finished product according to the disclosure has a rib which extends from the pin in a direction of >0° and <180°—alternatively a direction of >10° and <170°, alternatively a direction of >20° and <160°, alternatively a direction of >30° and <150°, alternatively a direction of >40° and <140°, alternatively a direction of >50° and <130°, alternatively a direction of >60° and <120°, alternatively a direction of >70° and <110°, alternatively a direction of >80° and <100°, alternatively a direction of 90°—with respect to the longitudinal axis and on which is formed the holding surface facing the head.

A rib is understood to mean any protruding element of the pin whose extension tangential to a circle around the longitudinal axis or whose extension along a circular arc or an elliptical arc around the longitudinal axis is longer than its extension in a direction radial to the longitudinal axis and/or longer than its extension in a direction parallel to the longitudinal axis. Embodiments of the disclosure are conceivable in which the holding surface is formed on a barb-shaped element, e.g., a barb-shaped element of a harpoon, whose extension tangential to a circle around the longitudinal axis or whose extension along a circular arc or an elliptical arc around the longitudinal axis is shorter than its extension in a direction radial to the longitudinal axis and/or longer than its extension in a direction parallel to the longitudinal axis. However, it is to be expected that this can only create a small holding surface or that a plurality of such barb-shaped elements, and thus a plurality of holding surfaces, must be provided in order to produce a good holding force. The fabrication of such a plurality of barb-shaped elements when manufacturing the semi-finished product may prove to be complex. By providing a rib, a single geometric element on the pin can already provide a holding surface with greater dimensions than is the case for barb-shaped elements.

The rib can have the shape of a triangle when viewed in a cross-section whose cutting plane contains the longitudinal axis. The rib would then have, for example, the cross-sectional shape of a saw tooth. In a specific embodiment, the cross-section of the rib has a polygonal shape in a cutting plane which contains the longitudinal axis; this can, for example, be rectangular—for example, square—but can also have a trapezoidal shape or the shape of a parallelogram or the shape of a polygon.

For the rib to extend in a certain direction means that the pin has, at least in the region of the rib, a section of the surface which is configured to be closer to the longitudinal axis and from which the rib rises at least in said direction (is further away from the longitudinal axis in this direction than the section of the surface of the pin adjoining the rib).

In a specific embodiment, the rib is formed to run circumferentially around the longitudinal axis. This can be provided by an annular rib. However, this can also be provided by a rib which winds helically around the longitudinal axis. A rib running circumferentially around the longitudinal axis makes maximal use of the space around the pin in order to provide a holding surface.

In a specific embodiment, the rib may extend along an arc around the longitudinal axis. An arc around the longitudinal axis is understood to mean any shape in which the rib does not run all the way around the longitudinal axis. A rib which runs circumferentially around the longitudinal axis is understood to mean a rib in which no gap is visible in the rib when viewed along the longitudinal axis, i.e., the rib is closed (regardless of whether this is provided by an annular rib or by a rib which winds helically around the longitudinal axis). Embodiments in which the rib extends around the longitudinal axis like a circular arc are conceivable. However, as will be explained in detail below, embodiments exist in which the height of the rib, which is understood to mean the extension of the rib in the direction radial to the longitudinal axis, varies over the extension of the rib. Thus, in this specific embodiment, the rib deviates from a circular arc-shaped extension around the longitudinal axis.

In a specific embodiment, the rib has a shoulder on which is formed a support surface having a surface normal having at least one component running tangentially to a circle around the longitudinal axis. In a specific embodiment, the surface normal of the support surface points in a direction tangential to a circle around the longitudinal axis. The shoulder may be provided along the rib, i.e., at any point along the extension of the rib around the longitudinal axis, e.g., the rib may be formed, starting from a first end, with a first height, wherein the rib then passes over the shoulder into a region in which the height of the rib is larger than in the first section. With regard to the design of its outer circumference, the rib can thus, for example, be of stepped design, wherein one or even several steps can be provided along the extension of the rib. In a specific embodiment, the rib has a sequence of shoulders. The circumferential surface of the rib may, for example, have a tooth profile. Retaining teeth protruding from the remaining part of the rib can also be provided as part of the circumferential surface of the rib.

In a specific embodiment, the shoulder, or, if there are several shoulders per rib, at least one shoulder of the rib, is provided in the form of the end of the rib. In more specific embodiments, the support surface is the surface connecting a radially, outward-facing, circumferential surface of the rib to the section of the surface of the pin from which the rib rises at an angle of >0° and >180°. The support surface can therefore be the end face of a rib extending along an arc around the longitudinal axis. The provision of a support surface on the rib offers the advantage that the rib can thus counteract a rotation around the longitudinal axis of the insert piece embedded in the resin of the composite element. In this way, not only is the holding surface facing the head enabled to hold the insert piece particularly well from being pulled out along the longitudinal axis, but, because of the support surface, it is also enabled to particularly well receive rotational forces—for example, for screwing in a screw in a specific embodiment having an internal thread provided in the fastening hole.

In a specific embodiment, the support surface is designed to be planar. In this case, it can be located on a plane which encloses the longitudinal axis. In this way, maximum absorption of rotational forces can be provided. However, it is also conceivable that advantages may be achieved if the support surface is planar, but embodied on a plane that does not enclose the longitudinal axis, and the support surface is configured as virtually a ramp on the rib. Such an angled embodiment of the support surface may, for example, facilitate the introduction of the semi-finished product into a fiber-woven fabric if such a fabric is used for producing a composite element according to the disclosure. It is also conceivable that advantages may be achieved if the support surface lies on a plane which does not contain the longitudinal axis and also does not lie parallel to the longitudinal axis. The support surface can therefore either face slightly towards the tip or slightly towards the head. This, too, may result in advantages during the production process of the composite element according to the disclosure. In a specific embodiment, the surface normal of the support surface is at an angle of <60°, alternatively <45°, alternatively <30°—to the tangent of the circle at the intersection of the support surface with a circle around the longitudinal axis.

In a specific embodiment, the height of the rib, where the height of the rib is understood to be its radial extension from the longitudinal axis (the distance of a point on the surface of the rib to the longitudinal axis along a line which is perpendicular to the longitudinal axis), is constant along its extension around the longitudinal axis. In this way, maximal use of the space around the pin can be made for forming a holding surface.

In a specific embodiment, the height of the rib varies along its extension around the longitudinal axis. In a specific embodiment, the height varies continuously at least over a section along the extension of the rib around the longitudinal axis. However, embodiments are also conceivable in which the height does not vary continuously—for example, in the above-described embodiment with a shoulder formed on the rib or in an embodiment in which the outer edge of the rib has a kink. Such a kink can be embodied, for example, at the base of a retaining tooth provided as part of the circumferential surface and protruding from the remaining part of the rib.

In a specific embodiment, the holding surface is planar and is located on a plane which is perpendicular to the longitudinal axis. However, embodiments are also conceivable in which the holding surface is not planar—for example, if the holding surface is formed on a rib which winds helically around the longitudinal axis. It is also conceivable for the holding surface to be formed by a section of the surface of a cone—for example, if the rib is tapered in the direction of the head.

In a specific embodiment, the rib has a complementary surface facing the tip which can exert a holding function comparable to the holding surface, e.g., counteracting reaction forces which press the insert piece deeper into the composite element, and which is designated as a complementary surface solely to distinguish it verbally from the holding surface facing the head. The complementary surface can be configured as a surface forming an angle to the longitudinal axis of >0° and <180°—alternatively an angle of >10° and <170°, alternatively an angle of >20° and <160°, alternatively an angle of >30° and <150°, alternatively an angle of >40° and <140°, alternatively an angle of >50° and <130°, alternatively an angle of >60° and <120°, alternatively an angle of >70° and <110°, alternatively an angle of >80° and <100°, alternatively an angle of 90°. Embodiments are conceivable in which the holding surface and the complementary surface are embodied with mirror symmetry with respect to a plane which is perpendicular to the longitudinal axis. Embodiments are also conceivable in which the holding surface and the complementary surface run parallel to one another.

In a specific embodiment, the rib has a circumferential surface. In a specific embodiment, all surface normals of the circumferential surface are perpendicular to the longitudinal axis and thus form a section of the surface of a cylinder around the longitudinal axis. In an alternative embodiment, all surface normals to the circumferential surface of the rib lie on a plane perpendicular to the longitudinal axis, wherein some surface normals do not intersect the longitudinal axis. In an alternative embodiment, the circumferential surface is a section of the surface of a cone.

In a specific embodiment, the rib has the holding surface and the complementary surface described above, and also a circumferential surface, wherein the complementary surface merges into the circumferential surface via an edge, and the circumferential surface merges into the holding surface via an edge.

In a specific embodiment, the pin of the semi-finished product according to the disclosure has several ribs. Embodiments are conceivable in which several ribs arranged at the same level are provided, wherein each rib extends along an arc around the longitudinal axis and is not formed circumferentially around the longitudinal axis. Grooves can be provided between the ribs provided at the same level—for example, in that the end faces of the ribs are configured as support surfaces.

Additionally or alternatively, embodiments are conceivable in which several ribs are provided on the pin offset relative to one another along the extension of the pin.

In a specific embodiment, the ribs are embodied identically to one another. This means that a rib provided in a first region of the pin along its extension in the longitudinal direction has a counterpart in another rib arranged in a region of the pin further along its extension in the longitudinal direction, viz., is embodied identically at least with respect to its geometric shape, even if the absolute size of each rib may differ, but is, typically, also embodied identically. If several ribs are provided in a region of the pin along its extension in the longitudinal direction, in a specific embodiment, each of the ribs provided in this region has a counterpart in a rib which is provided in another region of the pin along its extension in the longitudinal direction—at least with respect to its shape, and typically also with respect to its size. In a specific embodiment, the corresponding ribs are aligned, i.e., along a line which runs parallel to the longitudinal axis. However, embodiments are also conceivable in which the corresponding ribs are arranged offset relative to one another (not aligned) when viewed in the direction of the longitudinal axis.

In a specific embodiment, several ribs, each extending along an arc around the longitudinal axis, are provided in a first region of the pin along its longitudinal extension, and several ribs, each extending along an arc around the longitudinal axis, are provided in a second region of the pin along its longitudinal extension, wherein a recess is provided between each of the ribs provided in one region, and the recess between two ribs in the first region is aligned with the recess between two ribs of the second region. This forms a kind of “channel” which extends in a direction parallel to the longitudinal axis of the semi-finished product. If the resin in which the semi-finished product is embedded sets in this channel, a rigid strip extending along the longitudinal axis is produced in the resin, which can provide particularly good stability. In a specific embodiment, the recess is bounded by mutually opposite support surfaces formed on end faces of two adjacent ribs.

In a specific embodiment, several ribs, each extending along an arc around the longitudinal axis, are provided in a first region of the pin along its longitudinal extension, and several ribs, each extending along an arc around the longitudinal axis, are provided in a second region of the pin along its longitudinal extension, wherein a recess is provided between each of the ribs provided in one region, and the recess between two ribs in the first region is not aligned with the recess between two ribs of the second region.

In a specific embodiment, several ribs arranged offset relative to one another along the longitudinal extension of the pin are provided—typically, at least three—wherein, in this embodiment, the distance from the head to the rib closest to the head is seen to be equal to the distance between the ribs in the direction of the longitudinal axis. In an alternative embodiment, several ribs arranged offset relative to one another along the longitudinal extension of the pin are provided—alternatively, at least three—wherein, in this embodiment, the distance from the head to the rib nearest the head is different, and, typically, larger than the distance between the subsequent ribs in the direction of the longitudinal axis. The distances between the remaining ribs are, typically, equal to one another.

In a specific embodiment, the pin has several ribs arranged offset relative to one another in the longitudinal direction of the pin, wherein the points of maximum extension of each rib from the longitudinal axis lying on one side of the longitudinal axis lie on a straight line in each case—at least in a cross-section containing the longitudinal axis. In a specific embodiment, this straight line does not run parallel to the longitudinal axis. This is generally the case for the majority of, and typically all, cross-sections which contain the longitudinal axis. In a particularly specific embodiment, the straight line connecting the points of maximum extension of each rib from the longitudinal axis lying on one side of the longitudinal axis in such a cross-section forms an angle of <60°—alternatively <45°, alternatively <30°, alternatively <20°, alternatively <15°—with a straight line connecting the points of maximum extension of each rib from the longitudinal axis lying on the other side of the longitudinal axis in this cross-section.

In a specific embodiment, two or more ribs are provided which extend from the pin in a direction of >0° and <180°—particularly, at an angle of >10° and <170°—with respect to the longitudinal axis, on each of which is formed one of the holding surfaces facing the head, wherein the ribs are arranged spaced apart from one another in the direction of the longitudinal axis.

In a specific embodiment, the tip and/or the circumferential surface of the cross-section of the core of the semi-finished product and/or the enveloping lateral surface which encompasses the ribs is tapered in the direction of the longitudinal axis.

In a specific embodiment, the tip of the semi-finished product is conical or frustoconical. Embodiments are also conceivable in which the tip is conical or frustoconical, but has indentations introduced into this basic conical or frustoconical shape. In a specific embodiment, the cone angle of the cone or frustum of a cone is less than 80°—alternatively, less than 75°, alternatively, less than 72°, and alternatively, greater than 50°, alternatively greater than 60°, alternatively greater than 70°—and, in a particularly specific embodiment, is 71°.

In a specific embodiment, a recess is adjacent to the tip such that the holding surface is formed on a recess adjacent to the tip. Furthermore, embodiments are conceivable in which the holding surface is formed on a recess adjacent to the tip, and ribs are also provided on which further holding surfaces are formed.

In a specific embodiment, the head is plate-shaped or umbrella-shaped. The head may be cylindrical or frustoconical or cube-shaped, or may be in the form of a prismatoid.

In a specific embodiment, the head has a fastening element extending from the head in a direction opposite to the tip and forming a fastening protrusion. This connection piece can, for example, be a threaded pin or a T-piece or a ball or a sequence of at least 2 balls placed on top of each other or a pin with an internal thread introduced into the pin or a T-bolt or a mushroom-shaped element.

In a specific embodiment, a fastening hole is introduced into the head. In a conceivable embodiment, the fastening hole extends only along the entire extension of the head and does not extend into the pin. This increases the stability of the pin. In a specific embodiment, the fastening hole extends into the head and also into at least a part of the pin. In this way, the length of the fastening hole can be increased, and thus the length of the fastening potential for a fastening element to be introduced into the fastening element. In a specific embodiment, the fastening hole extends through the head, through the pin, and to the tip.

In a specific embodiment, a thread is introduced into the fastening hole.

In a specific embodiment, the fastening hole tapers in the direction of the tip.

In a specific embodiment, the fastening hole has a recess or an undercut when viewed in the direction from the head to the tip along the longitudinal axis.

In a specific embodiment, the fastening hole extends into the pin, wherein the pin has a constant wall thickness along the extension of the pin in the longitudinal direction in the region in which the fastening hole extends into the pin.

In a specific embodiment, the pin has a basic shape, the surface of which corresponds to the surface of a cylinder or corresponds to the surface of a frustum, wherein the rib or ribs extend away from this basic body in a direction forming an angle to the longitudinal axis of >0° and <180°.

In a specific embodiment, the semi-finished product has an insert piece extending into the region of the pin. The insert piece can, for example, be a hollow cylinder with an internal thread, which can be produced from a different material than the remaining material of the pin. If the semi-finished product is produced, for example, via injection molding, the semi-finished product can be produced by overmolding over this insert piece. Use of the insert piece can improve the interaction between the fastening hole and a fastening element inserted into the fastening hole; for example, a more load-bearing thread can be provided.

In a specific embodiment, the semi-finished product is at least partially—alternatively, entirely—made of a plastic. Included are non-conductive engineering plastics such as PA (polyamides) or POM (polyoxymethylene). Fiber-reinforced types in particular are also typical for the semi-finished product. However, the semi-finished product can also consist of all other plastics, or of metallic or non-metallic materials.

In a specific embodiment, an envelope curve around the basic body of the pin tapers in the direction of the tip.

In a specific embodiment, the tip is conical in shape, wherein the longitudinal axis passes through the tip of the cone. In an alternative embodiment, the tip is frustoconical, wherein the longitudinal axis forms the axis of symmetry of the cone. In a specific embodiment, the longitudinal axis forms the axis of symmetry of a fastening hole introduced into the head.

Furthermore, the disclosure proposes the use of a semi-finished product according to the disclosure for producing a fiber-reinforced composite element having a fastening hole or a fastening protrusion.

The disclosure further proposes a composite element having fibers embedded in a hardened resin and an insert piece likewise embedded in the resin. The insert piece has a head and a tip. A pin is provided between the head and the tip and extends along a longitudinal axis pointing from the head to the tip. A fastening hole is introduced in the head, and/or a fastening protrusion is provided on the head. The disclosure proposes that a recess be provided on the pin, on which recess is configured a holding surface facing the head and forming an angle to the longitudinal axis of >0° and <180°—alternatively an angle of >10° and <170°, alternatively an angle of >20° and <160°, alternatively an angle of >30° and <150°, alternatively an angle of >40° and <140°, alternatively an angle of >50° and <130°, alternatively an angle of >60° and <120°, alternatively an angle of >70° and <110°, alternatively an angle of >80° and <100°, alternatively an angle of 90°.

A composite element is an element made of a composite material. This is understood to mean a material made of two or more combined materials which possesses different material properties than its individual components. The composite element proposed according to the disclosure is typically produced from a fiber composite material. The fiber composite material generally comprises fibers and a resin, wherein, in the final state of the composite element (i.e., after the production of the composite element), the fibers are embedded in the hardened resin. Furthermore, the fiber composite material can have a filler and/or a hardener, or a filler and/or a hardener can be used in the production of the fiber composite material. The fiber composite can be layered, with different layers, wherein the layers differ from one another in that either different fibers and/or different resins are used in each layer. In a particularly specific embodiment, the fiber composite material is a single-layer composite material in which, although the fibers may be provided in multiple locations, they are fibers of the same type throughout, and the same resin is used throughout. The fiber composite material may have short fibers, long fibers, and/or continuous fibers. The fiber composite material generally comprises fiber-woven fabric. The fiber composite material may also have fractured fibers. In the method according to the disclosure for producing a composite element, it can be provided in a specific embodiment that the semi-finished product according to the disclosure be introduced into a fiber-woven fabric. During this introduction of the semi-finished product, which often takes place by insertion with the tip first, individual fibers of a fiber-woven fabric can fail. Thus, the composite element made of the fiber composite material can also have fractured fibers.

In specific embodiments the composite material is an epoxy resin having carbon fibers embedded therein.

In a specific embodiment, the insert piece embedded in the resin has been made of a semi-finished product according to the disclosure. All descriptions of quality specifications of the semi-finished product—in particular, geometrical specifications or material specifications—in this description are also to be understood as descriptions of characteristics of the insert piece.

In a specific embodiment, there is at least one fiber, and, typically, several fibers located above the holding surface or in the space located above the recess. As a result, pull-out resistance against pull-out of the insert piece can be increased.

In a specific embodiment, the insert piece has two ribs which are spaced apart from one another in the direction of the longitudinal axis, wherein at least one fiber—alternatively, a majority of fibers—lies between the two ribs.

In a specific embodiment, a portion of the hardened resin is located above the holding surface or in the space located above the recess. As a result, pull-out resistance against pull-out of the insert piece can be increased.

In a specific embodiment, the insert piece has two ribs spaced apart from one another in the direction of the longitudinal axis, wherein a portion of the resin is located between the two ribs.

The method according to the disclosure for producing a composite element according to the disclosure provides that a semi-finished product according to the disclosure be surrounded by fibers and a liquid resin, and the resin be hardened.

The composite element according to the disclosure is generally used as a structural element of a watercraft, an aircraft, or a land vehicle—alternatively, a motor vehicle or a bicycle. The composite element generally forms part of a frame structure of the motor vehicle or of the bicycle. Embodiments are also conceivable in which the composite element forms part of an attachment which is connected to the frame of a motor vehicle or a bicycle.

### BRIEF DESCRIPTION OF THE DRAWINGS

The disclosure is described in greater detail below, with reference only to exemplary embodiments of the disclosure, in which:

FIG. 1 shows a perspectival view of a first embodiment of a semi-finished product according to the disclosure;

FIG. 2 shows a side view of the semi-finished product according to the disclosure from FIG. 1;

FIG. 3 shows a section view taken along the line A-A shown in FIG. 2 of the semi-finished product according to the disclosure from FIGS. 1 and 2;

FIG. 4 shows a bottom view of the semi-finished product according to the disclosure from FIGS. 1 through 3;

FIG. 5 shows an enlargement of a partial region of the view shown in FIG. 4;

FIG. 6 shows a section view of the semi-finished product along the line F-F shown in FIG. 2;

FIG. 7 shows a section view of a second embodiment of a semi-finished product according to the disclosure;

FIG. 8 shows a section view of a third embodiment of a semi-finished product according to the disclosure;

FIG. 9 shows a section view of a fourth embodiment of a semi-finished product according to the disclosure;

FIG. 10 shows a schematic depiction of a sequence of method steps for producing a composite element according to the disclosure;

FIG. 11 shows a section view of a composite element according to the disclosure;

FIG. 12 shows a section view of a further embodiment of a semi-finished product according to the disclosure, and

FIG. 13 shows a view comparable to FIG. 6 of a further embodiment of the semi-finished product according to the disclosure.

### DETAILED DESCRIPTION

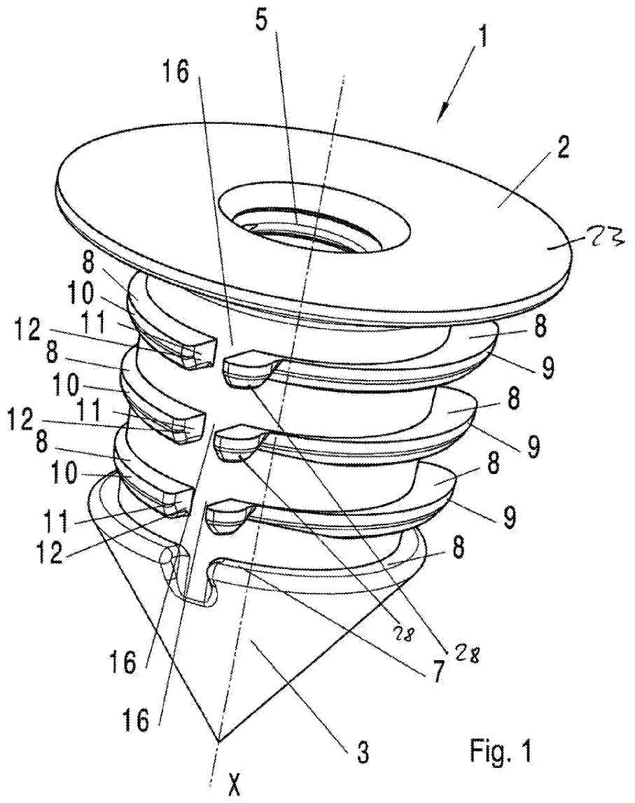

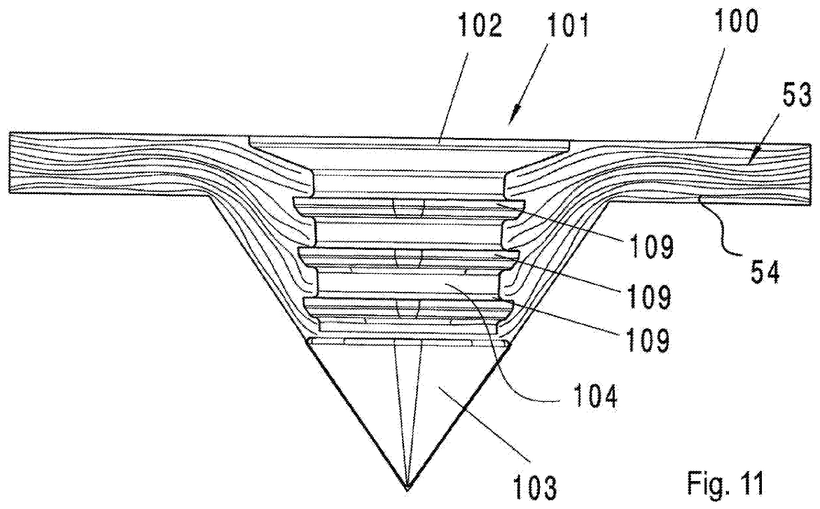

Referring to FIGS. 1-13, wherein like numerals indicate corresponding parts throughout the several views, a semi-finished product is illustrated and generally designated 1. In particular, the semi-finished product 1 shown in FIGS. 1 through 6 for producing a fiber-reinforced composite element 100 having a fastening hole or a fastening protrusion has a head 2 and a tip 3. Provided between the head 2 and the tip 3 is a pin 4 which extends along a longitudinal axis X pointing from the head 2 to the tip 3.

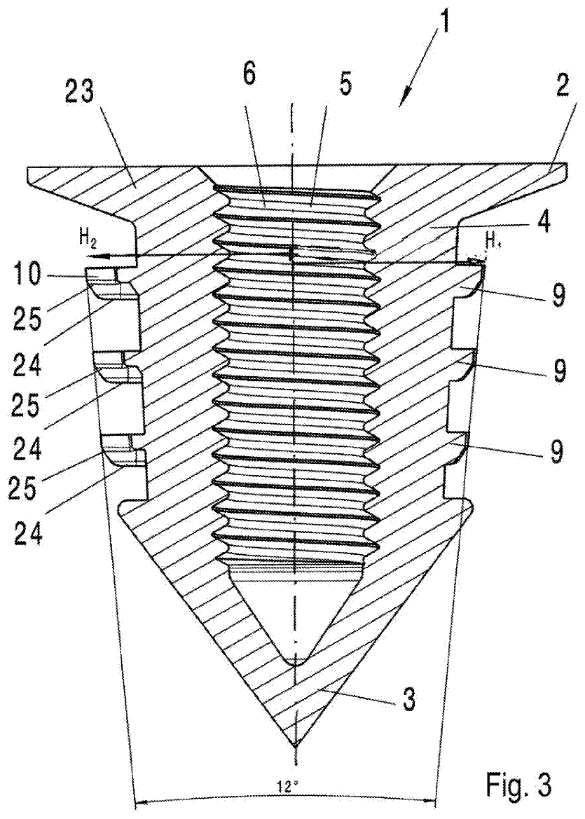

In the embodiment of a semi-finished product 1 shown in FIGS. 1 through 5, a fastening hole 5 is provided which is introduced into the head 2. As can be seen particularly well in FIG. 3, the fastening hole 5 extends from the head 2 through the pin 4 into the tip 3. FIG. 3 also shows particularly well that the fastening hole 5 is provided with an internal thread 6.

On the pin 4, at the transition from the tip 3 to the section of the semi-finished product 1 formed by the pin 4, a first recess 7 is provided on which a holding surface 8 forming an angle of 90° with the longitudinal axis X and facing the head 2 is embodied.

Furthermore, three groups of two ribs 9, 10, each arranged at the same level, are provided on the pin 4 offset relative to one another in the direction of the longitudinal axis X. The ribs 9,10 extend from the pin 4 in the direction of 90° to the longitudinal axis X. A holding surface 8 facing the head 2 is formed on each rib 9, 10. In relation to their maximum extension in the radial direction to the longitudinal axis X, each holding surface 8 on each rib 9, 10 forms a recess in the pin 4.

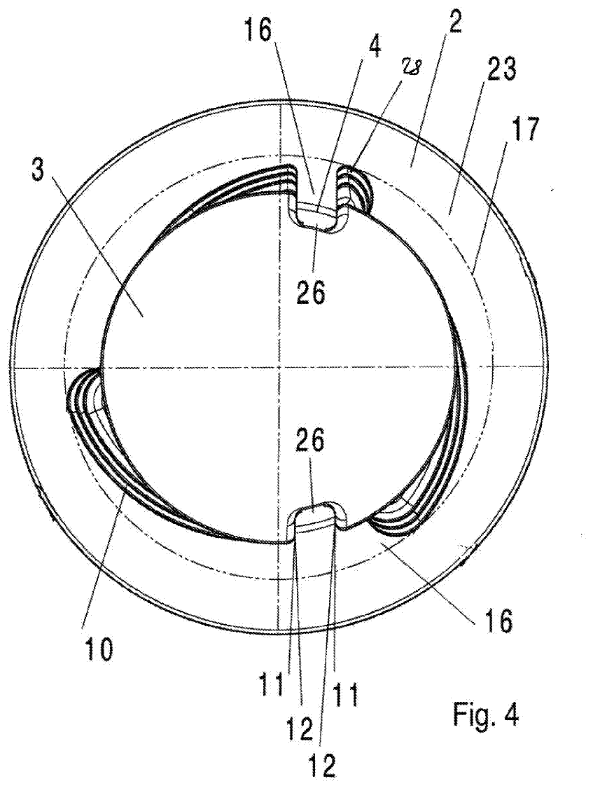

As can be seen especially well in FIG. 4 in particular, a shoulder 11 is formed on each rib 9, 10 at its end, on which a support surface 12 is formed. The support surface 12 of one shoulder 11 of the rib 9 faces a support surface 12 of the opposite shoulder 11 of the rib 10. In the case of the rib 9, the shoulder 11 is part of a retaining tooth 28 which projects radially from the remaining part of the rib.

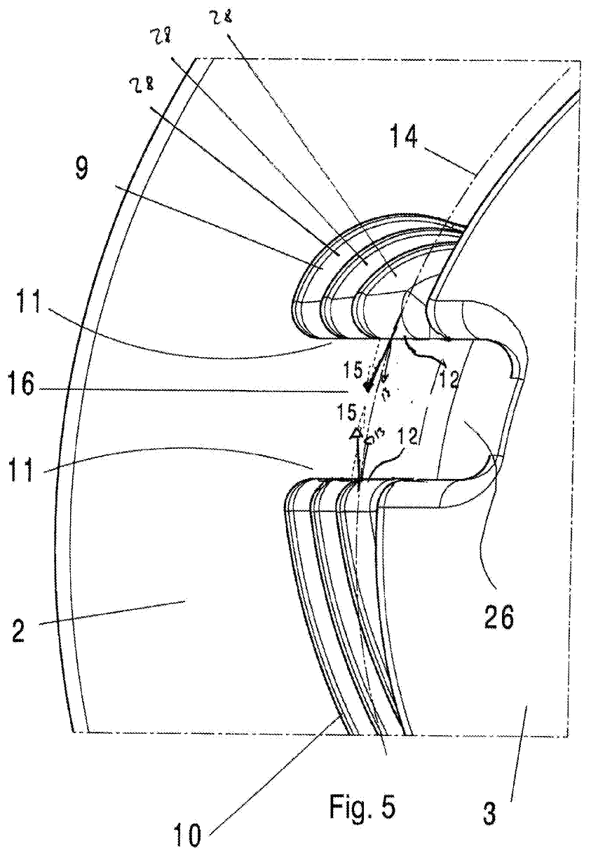

As FIG. 5 shows particularly clearly, each support surface 12 has a surface normal 13. FIG. 5 shows a section of a circle 14 around the longitudinal axis X. Furthermore, the arrows 15 show the tangential direction of this circle 14 at the points of intersection with the support surface 12. As can be seen particularly well in the representation in FIG. 5, the surface normal 13 has a component which runs tangentially to a circle 14 around the longitudinal axis X.

Through the formation of the shoulders 11 at the ends of the ribs 9, 10, a gap 16 is formed between two ribs 9, 10 arranged at the same level along the longitudinal extension of the longitudinal axis X (see FIGS. 1, 4, 5). As can be seen particularly well in FIGS. 1, 4, and 5, the gaps 16 between the ribs 9,10 arranged at the same level along the longitudinal extension of the longitudinal axis X are arranged one above the other (aligned) for all the ribs 9,10 present over the longitudinal extension, so that a type of channel forms which is formed along the longitudinal extension of the pin 4 and divides the ribs 9, 10. Embodiments are of course also conceivable in which each gap 16 between ribs 9, 10 arranged at the same level is not aligned with the gap 16 between two ribs 9,10 arranged at a different level, but offset instead.

FIGS. 1, 4, and 5 show that each rib 9, 10 is designed as an arc which extends around the longitudinal axis X. The ribs are therefore not formed to run around the whole circumference. The ribs are also not—as would be possible in other embodiments of the disclosure—embodied to be helical around the longitudinal axis, as is known in the case of an external thread of a screw.

In FIG. 3, arrows H₁ and H₂ emphasize that the distance between each outer point of a rib and the longitudinal axis X is different. The distance between each outermost point of the rib in the radial direction to the longitudinal axis X at a point of the extension of the rib around the longitudinal axis X is understood as its height. As FIG. 4 highlights particularly clearly, the height of a rib 9, 10 changes over its extension along the arc around the longitudinal axis X along which the rib 9, 10 extends. Thus, the outermost points of the rib do not all lie on a circle. This is illustrated by the circle 17 drawn in FIG. 4. The circle 17 around the longitudinal axis X connects the radially outermost points of the rib 9 and the rib 10.

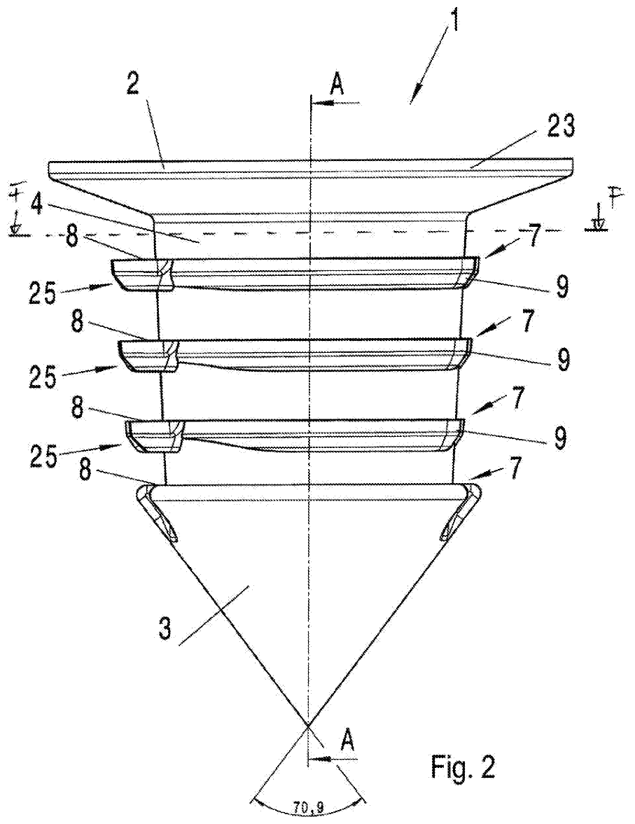

FIGS. 2 and 3 show particularly well that the outer contour of the pin 4 is that of a cylinder or that of a frustum having a very small slant (taper in the direction of the tip 3). The result—as FIG. 3 highlights particularly clearly—is that the radial extension of each rib 9, 10 (i.e., the degree to which each rib 9, 10 projects beyond the outer circumference 20 of the pin 4 in the radial direction to the longitudinal axis X) varies along its longitudinal extension (its extension along the arc around the longitudinal axis X). The base 26 of each recess between each rib 9 and 10 is part of the surface of the outer circumference of the cylindrical or frustoconical basic body of the pin 4.

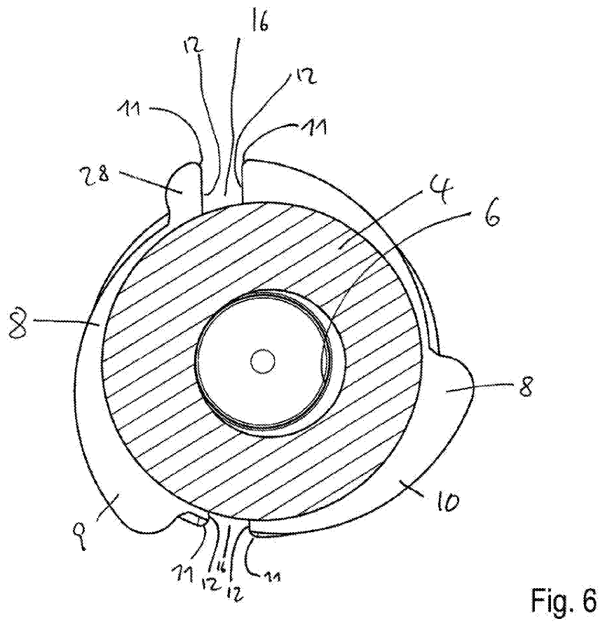

FIG. 6 shows that the pin has a hollow cylindrical cross-section.

FIG. 3 highlights that the height of the respective rib 9, 10 at a point along its longitudinal extension (its extension along the arc around the longitudinal axis X) is larger compared to a rib located closer to the tip 3. In the embodiment shown in FIGS. 1 through 6, the height of each rib 9, 10 along its longitudinal extension is selected such that, in each section of the semi-finished product 1, which also contains the longitudinal axis X and passes through the ribs 9, 10, the points of maximum extension of each rib 9, 10 lie on lines 21, 22, which form an angle of 12° to one another.

As can be seen particularly well in FIG. 4 and FIG. 5, the ribs 10 are each identical, and the ribs 9 are also each identical, meaning that all the ribs 10 have the same shape, albeit in different sizes, and all the ribs 9 have the same shape, albeit in different sizes.

FIG. 2 shows that the tip is configured as a cone having an included angle of 70.9°.

As can be clearly seen from FIGS. 1 through 5, the head 1 has a circumferential flange 23 via which the semi-finished product can be supported on other elements.

FIGS. 2 and 3 show particularly well that each rib 9, 10 has a surface forming the holding surface 8 and facing the head 2, which runs at an angle of 90° to the longitudinal axis X and has a lower side 24 which likewise runs at an angle of 90° to the longitudinal axis and faces the tip 3. The upper side and lower side therefore run parallel to one another. The upper side and the lower side are connected by a circumferential surface 25. In cross-sections of the semi-finished product which contain the longitudinal axis X, the circumferential surface runs at an angle to the longitudinal axis X (not parallel to the longitudinal axis and also not 90° to the longitudinal axis). The rib could be said to have a bevel at its outer circumference.

The semi-finished product 1 shown in FIGS. 1 through 6 is configured as an injection-molded part made of a plastic.

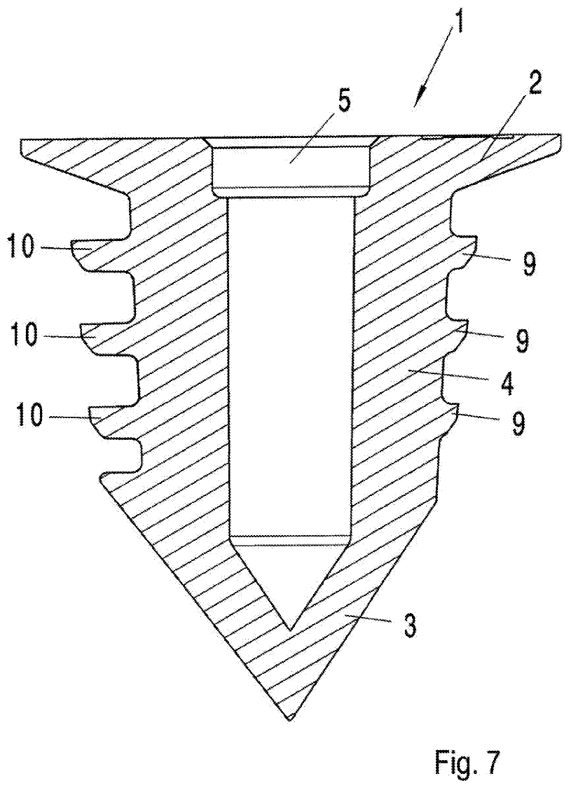

The embodiment in FIG. 7 differs from the embodiment in FIGS. 1 through 6 in that a fastening hole 5 which extends into the pin 4 and into the tip 3 is embodied in the head 2 and is of smooth-walled design, and does not have the internal thread 6 of the embodiment shown in FIGS. 1 through 6.

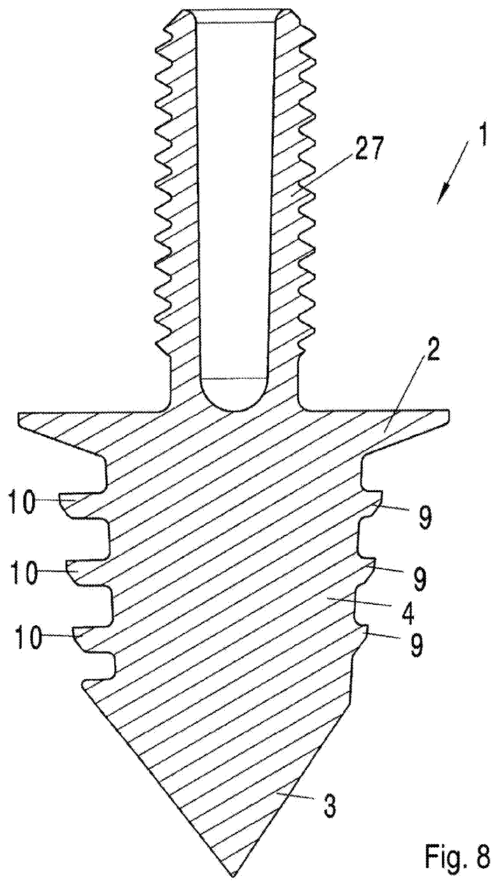

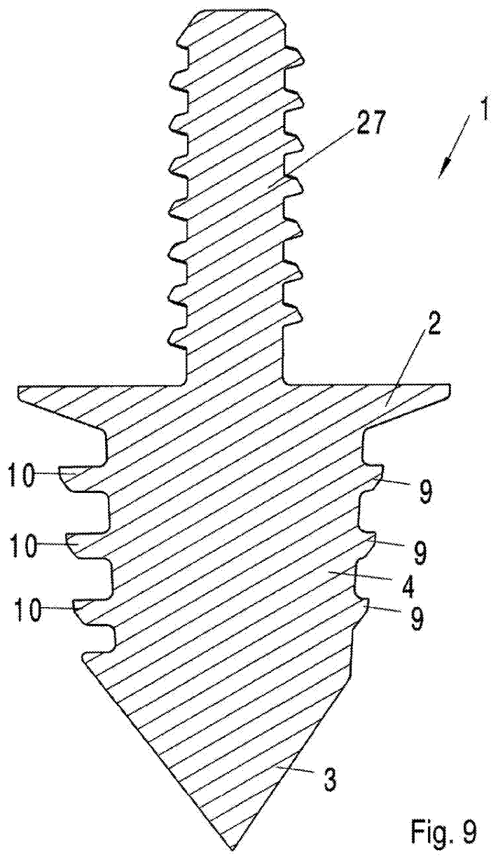

In the embodiments of FIGS. 8 and 9, no fastening hole is provided in the head 2. Instead, a fastening protrusion is provided on the head 2. In the embodiment in FIG. 8, the fastening protrusion is configured as a threaded pin extending along the longitudinal axis X. The same applies to the embodiment of FIG. 9. In contrast to the threaded pin 27 of the embodiment in FIG. 9, which is made of solid material, the threaded pin in the embodiment shown in FIG. 8 is hollow.

For reasons of clarity, the same reference signs are used in the embodiments in FIGS. 7, 8, and 9 as in the embodiment in FIGS. 1 through 6. With the exception of the specific configuration of the fastening hole or of the fastening protrusion, the semi-finished products 1 in the embodiments in FIGS. 7, 8, and 9 are identical to the embodiment in the example in FIGS. 1 through 6.

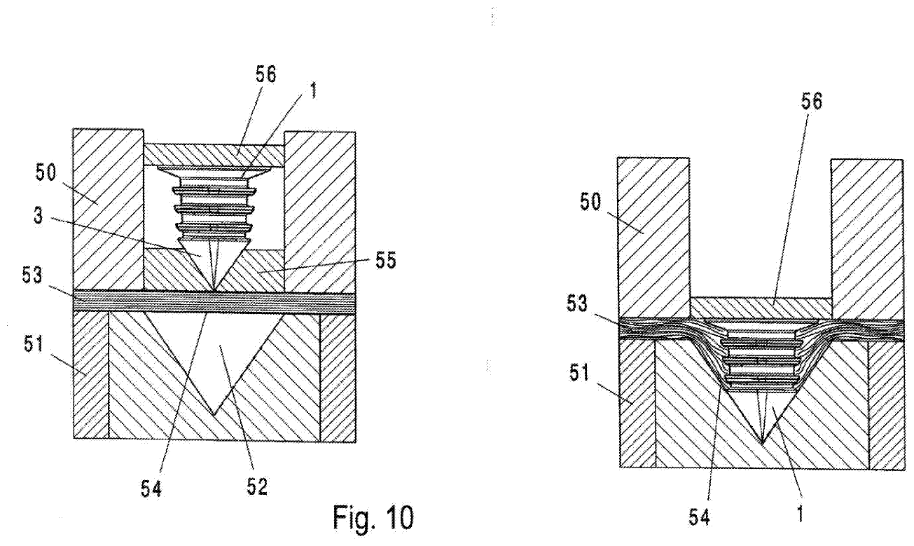

FIG. 10 schematically shows the sequence of actions of a method for producing the composite element 100 according to the disclosure. For this purpose, a device is provided having an upper part 50 in which a semi-finished product 1 according to the disclosure is held. The device used further has a lower part 51. A cavity 52 is embodied in the lower part 51, the shape of which cavity is adapted to the shape of the tip 3 of the semi-finished product 1. Several layers of a woven fabric 53 of fibers 54 are clamped between the upper part 50 and the lower part 51. Above the woven fabric 53, a resin supply 55 is located in the upper part 50. The tip 3 of the semi-finished product 1 held in the upper part 50 plunges into the resin supply 55. Furthermore, a punch 56 is provided which can press the semi-finished product 1 through the resin supply 55 into the woven fabric 53. The resin supply 55 is liquefied at the time of insertion of the semi-finished product 1. The liquefied resin of the resin supply 55, together with the semi-finished product 1, is pressed between the fibers 54 of the woven fabric 53 by the punch 56. The tip 3 of the semi-finished product 1 parts the fibers 54 of the woven fabric 53. This can take place, on the one hand, by the tip 3 pushing the fibers of the woven fabric to the side. Additionally or alternatively, it is also conceivable for the tip 3 of the semi-finished product 1 to separate the fibers 54.

The resin is hardened after insertion of the semi-finished product 1. After the resin hardens, the composite element according to the disclosure is finished and can be removed from the device. The semi-finished product 1 has then become an insert piece 101 embedded in the resin of the composite element. Since the insert piece 101 has been produced from the semi-finished product 1, the insert piece 101 has a head 102 and a tip 103, wherein a pin 104 is provided between the head 102 and the tip 103, which pin extends along a longitudinal axis X pointing from the head 102 to the tip 103. The insert piece 101 has ribs 109 projecting from the pin 104.

The enlarged depiction of the composite element according to the disclosure in FIG. 10 shows particularly well how the fibers 54 of the woven fabric 53 lie between the ribs 109. In the hardened state of the resin, the resin is also located between the ribs 109. By arranging the resin and the fibers 54 between the ribs 109, it is possible via large holding forces to counteract pull-out of the insert piece 101 from the composite element 100.

As a result of the varying height of the ribs 9 and 10, shown particularly well in FIGS. 4 and 5, but particularly also as a result of the shoulders 11 provided on the ribs 9,10 and their support surfaces 12, it is possible via particularly large holding forces to counteract any attempt to rotate the insert piece 101 in the hardened resin. This makes it possible, for example, to screw a threaded pin into an internal thread 6 in a fastening hole 5 using large tightening forces.

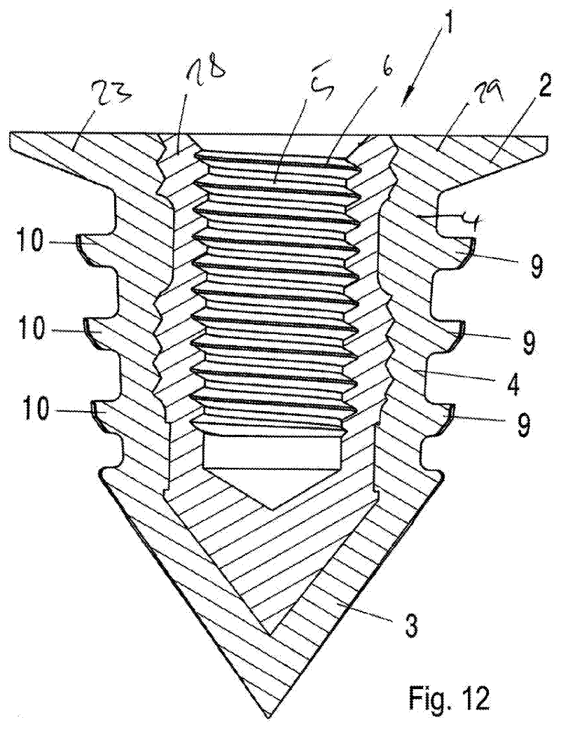

FIG. 12 shows an embodiment of the semi-finished product according to the disclosure in which a metal sleeve 28 having the fastening hole 5 and the internal thread 6 provided in the fastening hole 5 has been overmolded with a plastic material 29 to form the semi-finished product according to the disclosure. The representation in FIG. 12 was based upon the representation in FIG. 2 in order to show that the embodiment shown in FIG. 12 differs from the embodiment shown in FIG. 2 only with regard to its inside, viz., the metal sleeve 28 arranged on the inside, while the external form of the exemplary embodiment shown in FIG. 12 is equivalent to that of the exemplary embodiment shown in FIG. 2.

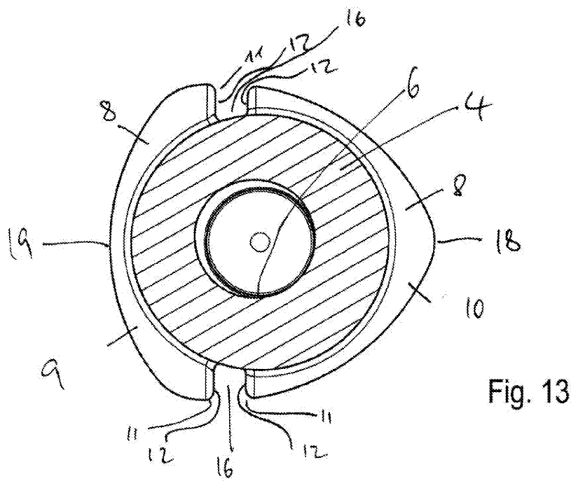

The embodiment shown in FIG. 13 is configured in a manner comparable to the embodiment shown in FIGS. 1 through 6; however, it differs in the geometry of the circumferential surface of the ribs 9, 10. While the circumferential surface of the ribs 9, 10 in the embodiment shown in FIGS. 1 through 6 is formed with steps and retaining teeth, the circumferential surface of the ribs 9, 10 in the embodiment in FIG. 13 is configured in a simpler way. It can also be seen in FIG. 13 that the height of each rib 9, 10 varies continuously along its longitudinal extension (its extension along the arc around the longitudinal axis X). With the exception of the shoulders 11 provided at the end of the rib 9, 10 in each case, the ribs 9, 10 have no steps. The rib 10 has a vertex 18 which is configured to be more incisive than a comparable vertex 19 of the rib 9, but the change in height is still continuous at the vertices 18, 19. The vertices 18, 19 are not designed as edges.

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, The term “about” applies to both numerical values when associated with a range of values. Moreover, the term “about” may apply to numerical values even when not explicitly stated.

Generally, as used herein a hyphen “-” or dash “—” in a range of values is “to” or “through”; a “>” is “above” or “greater-than”; a “≥” is “at least” or “greater-than or equal to”; a “<” is “below” or “less-than”; and a “≤” is “at most” or “less-than or equal to.” On an individual basis, each of the aforementioned applications for patent, patents, and/or patent application publications, is expressly incorporated herein by reference in its entirety in one or more non-limiting embodiments.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

What is claimed is:

1. A semi-finished product for producing a fiber-reinforced composite element defining a fastening hole or a fastening protrusion, wherein:
the semi-finished product has a head and a tip, and a pin is provided between the head and the tip, which pin extends along a longitudinal axis extending from the head to the tip,
wherein a fastening hole is defined by the head, and/or a fastening protrusion extends from the head,
wherein a recess is defined by the pin, on which recess a holding surface is presented which faces the head and is arranged at an angle to the longitudinal axis of >0° and <180°.

2. The semi-finished product according to claim 1, further comprising a rib which extends from the pin in a direction of >0° and <180° with respect to the longitudinal axis, and on which the holding surface facing the head is presented.

3. The semi-finished product according to claim 2, wherein the rib is formed circumferentially around the longitudinal axis or extends along an arc around the longitudinal axis.

4. The semi-finished product according to claim 2, wherein the rib has a shoulder on which is formed a support surface having a surface normal having at least one component running tangentially to a circle around the longitudinal axis.

5. The semi-finished product according to claim 2, comprising two or more ribs extending from the pin in a direction of >0° and <180° with respect to the longitudinal axis, on each of which is presented one of the holding surfaces facing the head, wherein the ribs are arranged spaced apart from one another in the direction of the longitudinal axis.

6. The semi-finished product according to claim 1, wherein the tip and/or the circumferential surface of the cross-section of the core of the pin and/or the enveloping lateral surface which encompasses the ribs taper in the direction of the longitudinal axis.

7. The semi-finished product according to claim 1, comprising the fastening hole defined by the head, and wherein the fastening hole extends into the pin.

8. The semi-finished product according to claim 1, wherein the fastening hole has a thread.

9. The semi-finished product according to claim 1, wherein a fastening protrusion extends from the head and is designed in the form of a ball, a pin with an external thread or internal thread, or a T-bolt.

10. (canceled)

11. A composite element having fibers embedded in a hardened resin and an insert piece likewise embedded in the resin, said insert piece having a head and a tip, wherein a pin is provided between the head and the tip, which pin extends along a longitudinal axis extending from the head to the tip,
wherein a fastening hole defined by the head, and/or a fastening protrusion extends from the head,
wherein a recess is defined by the pin, on which recess a holding surface is presented which faces the head and is arranged at an angle to the longitudinal axis of >0° and <180°.

12. The composite element according to claim 11, wherein the insert piece is produced from a semi-finished product.

13. A method for producing a composite element according to claim 11, comprising a semi-finished product surrounded by fibers and hardened resin.
